(19) United States
(12) Patent Application Publication
(10) Pub. No.: US 2016/0147741 A1
(43) Pub. Date: May 26, 2016

(54) TECHNIQUES FOR PROVIDING A USER INTERFACE INCORPORATING SIGN LANGUAGE

(71) Applicant: Adobe Systems Incorporated, San Jose, CA (US)

(72) Inventors: Sonal Dawar, Haryana (IN); Nandan Jha, Uttar Pradesh (IN)

(73) Assignee: Adobe Systems Incorporated

(21) Appl. No.: 14/554,776

(22) Filed: Nov. 26, 2014

(51) Int. Cl. G06F 17/28; G06F 3/0484; G09B 21/00; G06F 3/0482

(52) U.S. Cl. CPC G06F 17/289; G06F 3/0482; G06F 3/04842; G09B 21/009

(57) ABSTRACT

Disclosed are various embodiments for building and providing a user interface of an application that is presented using sign language in an animation within the user interface. In one implementation, a computer initiates execution of an application that is configured to provide a user interface (UI) in at least one available language that includes a sign language. Input is received from a user navigating to an interface element of the UI. The interface element presents one or more actions of the application that are available for selection. In response to the user navigating to the interface element of the UI, an animation is displayed in the UI using the sign language that corresponds to the one or more actions that are available for selection.

### BACKGROUND

Within the general population, a significant number of people may regularly communicate using one or more sign languages, such as American Sign Language (ASL). Among those who use a sign language, some people may simply have a preference to use it on occasion instead of oral or written languages, while other people, particularly those who are both deaf and cannot speak, may not be fluent in a language other than a sign language. However, existing applications do not provide a user interface that accommodates users who wish to interact with the applications using a sign language.

### SUMMARY

Various aspects of the present invention relate to providing a user interface for an application that is presented using sign language in an animation within the user interface. In one implementation, a computer generates a user interface (UI) for an application that is configured to provide at least one of a plurality of available languages that includes a sign language. The sign language may include American Sign Language (ASL), Brazilian Sign Language (LSB), Indo-Pakistani Sign Language (IPSL), and Chinese Sign Language (CSL). The user may configure the UI to enable or disable presentation of the sign language. Input is received from a user navigating to an interface element of the UI. The interface element presents one or more actions of the application that are available for selection. In response to the user navigating to the interface element of the UI, an animation is displayed in the UI using the sign language that corresponds to the one or more actions that are available for selection. The animation may change in response to which one of various possible interface elements the user has navigated. The animation may be presented in a portion of the UI that may be moved to various locations within the UI.

In another implementation, a computing device retrieves a text string from a data store, where the text string is constructed in a written language and is associated with source code for a user interface of an application. A translation of the text string from the written language to an animation in a sign language is received and stored in a data store. Executable code for the application is built from the source code. The executable code for the user interface of the application includes the text sting in the written language and the animation in the sign language. The computing device may build a plurality of executable codes of the application that are executable on a plurality of different processors.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIGS. 2 and 3 are pictorial diagrams of an example user interface rendered by a client in the networked environment of FIG. 1 according to various embodiments of the present disclosure.

FIG. 4 is another drawing of a networked environment according to various embodiments of the present disclosure.

FIG. 5 is a flowchart illustrating one example of functionality implemented as portions of an application service executed in a computing environment in the networked environment of FIG. 1 according to various embodiments of the present disclosure.

FIG. 6 is a flowchart illustrating one example of functionality implemented as portions of a build service executed in a computing environment in the networked environment of FIG. 4 according to various embodiments of the present disclosure.

FIG. 7 is a schematic block diagram that provides one example illustration of a computing environment employed in the networked environment of FIGS. 1 and 4 according to various embodiments of the present disclosure.

### DETAILED DESCRIPTION

Disclosed herein are various embodiments relating to providing a user interface of an application that is presented using sign language in an animation within the user interface. As a non-limiting example, the application may be configured to provide a user interface in both written language, such as English, and a sign language, such as ASL, simultaneously. The user interface may present the sign language through use of a series of animations presented in an animation window. If the user navigates with an input device to the “Edit” interface element of the main menu of the user interface, an animation is shown in the animation window identifying the “Edit” menu item in ASL. In addition, other animations may be presented for each of the interface elements of the submenu of the Edit menu item, such as “Copy,” “Paste,” “Cut,” etc. If the user navigates a pointer to different interface elements of the submenu, the animations may also reflect the particular submenu item over which the pointer hovers. In the following discussion, a general description of the system and its components is provided, followed by a discussion of the operation of the same.

As used herein, an “interface element” is a user interface component with which a user interacts to direct an application or obtain information from the application. For example, interface elements may include buttons, menus, links, lists, tabs, checkboxes, etc.

As used herein, an “animation” refers to a video or other sequence of images, gestures, or text that can convey the illusion of motion and/or shape change. The animations may be computer-generated or live-action captured from a sign language presenter.

As used herein, a “text string” (or simply a “string”) is a sequence of characters that make up a word or a phrase in a written language, such as the strings “File” or “Send to printer.” In implementations of the user interface described herein where a plurality of languages may be used, one text string in a given language may serve as the default or “core” string from which other text strings in other written languages and/or animations in sign languages may be translated.

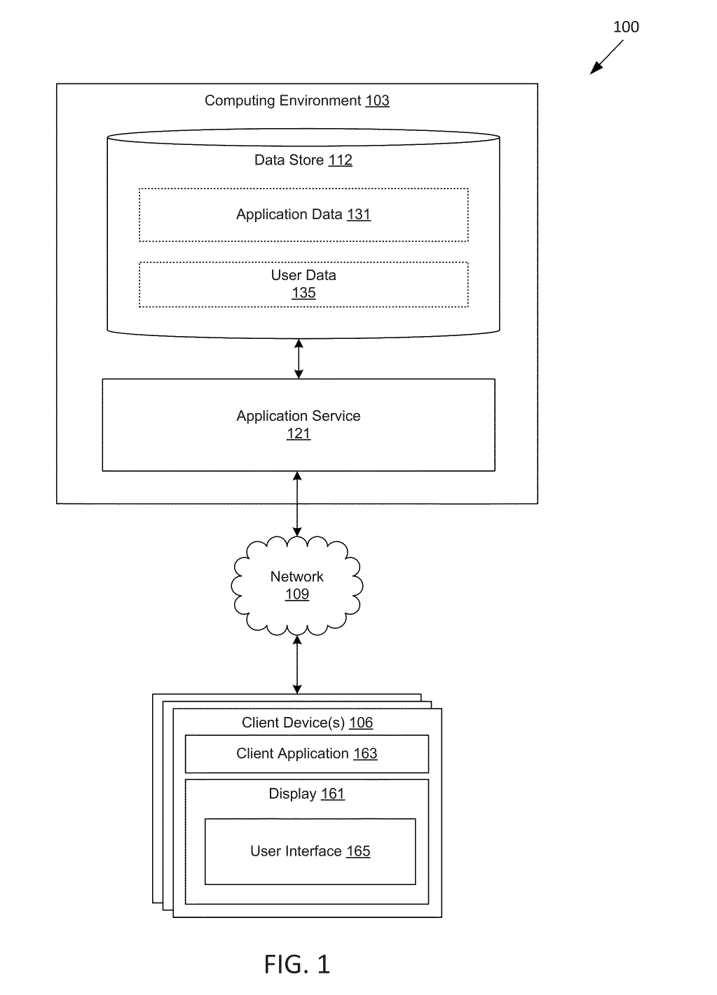

With reference to FIG. 1, shown is an illustrative networked environment 100 according to various embodiments. The networked environment 100 includes a computing environment 103 and a client device 106, which are in data communication with each other via a network 109. The network 109 includes, for example, the Internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks. Although the functionality described herein is shown in the context of the networked environment 100, other implementations are possible, such as implementing the functionality in a single computing device (e.g. desktop computer or mobile device), as a plug-in or auxiliary feature of another service executed in a computing device, and/or in arrangements of computing devices other than those shown in FIG. 1.

The computing environment 103 may comprise, for example, a server computer or any other system providing computing capability. Alternatively, the computing environment 103 may employ a plurality of computing devices that may be arranged, for example, in one or more server banks or computer banks or other arrangements. Such computing devices may be located in a single installation or may be distributed among many different geographical locations. For example, the computing environment 103 may include a plurality of computing devices that together may comprise a hosted computing resource, a grid computing resource and/or any other distributed computing arrangement. In some cases, the computing environment 103 may correspond to an elastic computing resource where the allotted capacity of processing, network, storage, or other computing-related resources may vary over time.

Various applications and/or other functionality may be executed in the computing environment 103 according to various embodiments. Also, various data is stored in a data store 112 that is accessible to the computing environment 103. The data store 112 may be representative of a plurality of data stores 112 as can be appreciated. The data stored in the data store 112, for example, is associated with the operation of the various applications and/or functional entities described below.

The components executed on the computing environment 103, for example, include an application service 121 and other applications, services, processes, systems, engines, or functionality not discussed in detail herein. The application service 121 represents any application which, when executed, provides a user interface which can be configured to use one or more languages that includes a sign language.

The data stored in the data store 112 includes, for example, application data 131, user data 135, and potentially other data. The application data 131 includes logs and/or configuration data for the application service 121, data stored by users of the application service 121, metadata associated with the data produced by users, etc. The user data 135 includes various data associated with users of the application service 121 and/or who have data stored in the application data 131. The user data 135 may include user credentials, identifiers of data stored by the user in the application data 131, preferences, and/or other possible data.

The client 106 is representative of a plurality of client devices that may be coupled to the network 109. The client 106 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. The client 106 may include a display 161. The display 161 may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client 106 may be configured to execute various applications such as a client application 163 and/or other applications. The client application 163 may be executed in a client 106, for example, to access network content served up by the computing environment 103 and/or other servers, thereby rendering a user interface 165 on the display 161. To this end, the client application 106 may comprise, for example, a browser, a dedicated application, etc., and the user interface 165 may comprise a network content page, an application screen, etc. The client 106 may be configured to execute applications beyond the client application 163 such as, for example, email applications, social networking applications, word processors, spreadsheets, and/or other applications.

Next, a general description of the operation of the various components of the networked environment 100 is provided. To begin, a user operating the client 106 employs the client application 163 to establish a communication session with the application service 121. The communication session may be carried out using various protocols such as, for example, hypertext transfer protocol (HTTP), simple object access protocol (SOAP), representational state transfer (REST), user datagram protocol (UDP), transmission control protocol (TCP), and/or other protocols for communicating data over the network 109. In some implementations, the user is authenticated to the application service 121 using one or more user credentials.

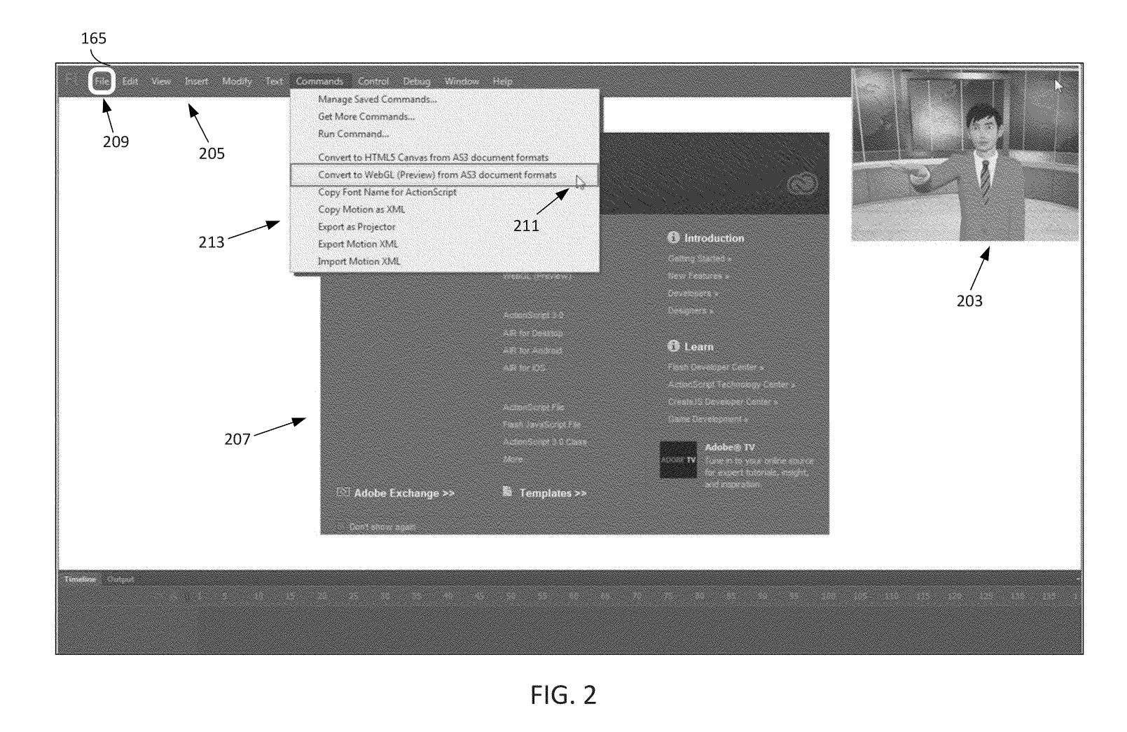

Thereafter, the user may navigate or otherwise interact with the user interface 165 generated by the application service 121, such as shown in FIG. 2. When the application service 121 is configured to enable a sign language in the user interface 165, an animation window 203 may be displayed that presents a series of one or more animations in a sign language that relate to interface elements of the user interface 165 and/or application-related events. The animations may be stored in one or more formats, such as Adobe Flash®, MPEG-1/2/4 (Motion Pictures Expert Group), animated GIF (Graphic Interchange Format), animated PNG (Portable Network Graphics), and/or other possible data formats as can be appreciated. The sign languages may include one or more of American Sign Language (ASL), Brazilian Sign Language (LSB), Indo-Pakistani Sign Language (IPSL), Chinese Sign Language (CSL), and/or other possible sign languages.

In some implementations, prior to receiving input from a user navigating the user interface 165, a series of animations may be presented in the animation window 203 that relate to some or all of the interface elements in the menus 205/207. For example, each item within the menu 205 may be highlighted one at a time, such as by the highlight 209, while an animation is presented that reflects the corresponding item as it is highlighted. In the exemplary user interface of FIG. 2, the interface elements of the menus 205/207 are presented in a written language in addition to the sign language presented in the animation window 203. However, in some implementations, the user interface 165 may only use sign language to present the various interface elements. In these embodiments, instead of representing the interface elements with labels in a written language, the interface elements may be represented with icons and/or other indications of the presence of an interface element.

Once input is received from the user to navigate among the interface elements of the user interface 165, such as represented by the pointer 211, the animation in the animation window 203 may change to present an animation in the sign language that corresponds to the particular interface element to which the user has navigated. For example, prior to the user selecting the interface element for the “Commands” item from the menu 205, the user may have hovered the pointer 211 over the item resulting in an animation that expresses “Commands” and/or a description of the “Commands” menu item in the sign language. In response to the user activating the interface element for the “Commands” menu item, the “Commands” submenu 213 may be displayed in the user interface 165. Continuing the example, an animation in the sign language may then be presented that corresponds to one or more submenu items. In the event that the pointer 211 is navigated to an interface element for one of the submenu items, such as shown in FIG. 2, the particular submenu item may be highlighted and a sign language animation corresponding to the particular submenu item may be presented in the animation window 203.

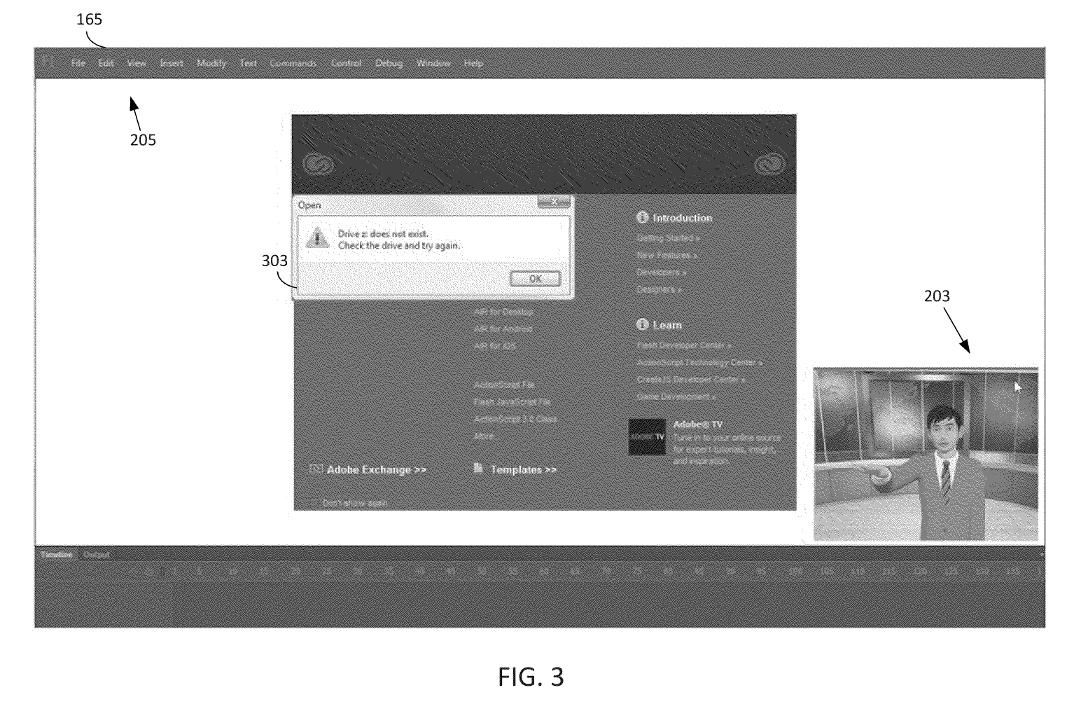

Referring next to FIG. 3, shown is another exemplary illustration of the user interface 165. When the application service 121 is configured to enable a sign language in the user interface 165, an animation window 203 may be displayed that presents various animations in a sign language that relates to interface elements of the user interface 165 and/or application-generated events. In some implementations, the user may move the animation window 203 to various locations within the user interface 165 as demonstrated by placement of the animation window 203 in the lower right of the user interface 165 in FIG. 3 instead placement in the upper-right of the user interface 165 as shown in FIG. 2. Movement of the animation windows 203 may be initiated via the menu 205, by “dragging” the animation windows 203 with an input device for the user interface 165, and/or through other possible actions.

In other implementations, interface elements such as the event message 303 may be produced in response to various possible application-generated events, such as a storage device no longer being available, the user not having the necessary authorization for a requested action, and/or other possible circumstances. In these implementations, an animation corresponding to the event message 303 may be presented when such an animation is available. In addition, animations may also be presented in the animation window 203 for the various actions that are available in the event message 303, such as “OK,” “Cancel,” “Retry,” etc.

In still other implementations, the user interface 165 may provide one or more interface elements related to enabling or disabling the animation window 203 used to present the animations in a sign language, changing the sign language used for the animations, enabling or disabling the written language used in the user interface 165, and/or other possible actions associated with the language of the user interface 165. The interface elements associated with the language of the user interface 165 may be accessible via the menu 205 or elsewhere on the user interface. For example, the particular sign language used may be selected from among the available sign languages by “clicking” the animation window in order to view the available sign languages.

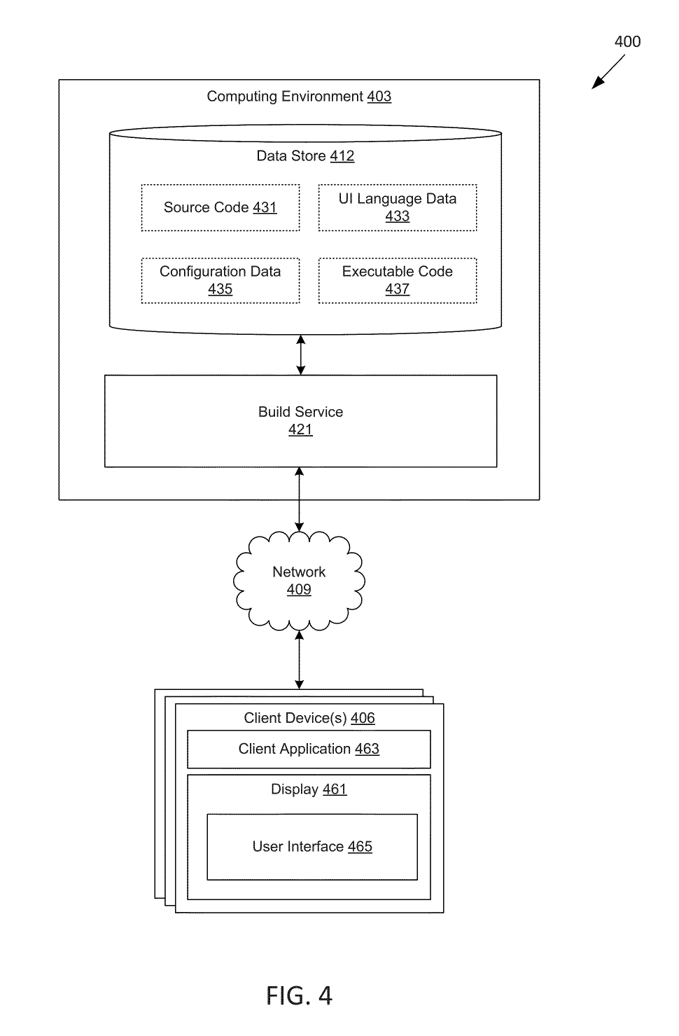

Turning now to FIG. 4, shown is an illustrative networked environment 400 according to various embodiments. The networked environment 100 includes a computing environment 403 and a client device 406, which are in data communication with each other via a network 409. The network 409 includes, for example, the Internet, intranets, extranets, WANs, LANs, wired networks, wireless networks, or other suitable networks, etc., or any combination of two or more such networks. For example, such networks may comprise satellite networks, cable networks, Ethernet networks, and other types of networks. Although the functionality described herein is shown in the context of the networked environment 400, other implementations are possible, such as implementing the functionality in a single computing device (e.g. desktop computer or mobile device), as a plug-in or auxiliary feature of another service executed in a computing device, and/or in arrangements of computing devices other than those shown in FIG. 4.

The computing environment 403 may comprise, for example, a server computer or any other system providing computing capability. Alternatively, the computing environment 403 may employ a plurality of computing devices that may be arranged, for example, in one or more server banks or computer banks or other arrangements. Such computing devices may be located in a single installation or may be distributed among many different geographical locations. For example, the computing environment 403 may include a plurality of computing devices that together may comprise a hosted computing resource, a grid computing resource and/or any other distributed computing arrangement. In some cases, the computing environment 403 may correspond to an elastic computing resource where the allotted capacity of processing, network, storage, or other computing-related resources may vary over time.

Various applications and/or other functionality may be executed in the computing environment 403 according to various embodiments. Also, various data is stored in a data store 412 that is accessible to the computing environment 403. The data store 412 may be representative of a plurality of data stores 412 as can be appreciated. The data stored in the data store 412, for example, is associated with the operation of the various applications and/or functional entities described below.

The components executed on the computing environment 403, for example, include an build service 421 and other applications, services, processes, systems, engines, or functionality not discussed in detail herein. The build service 421 is executed to build an executable application, such as the application service 121 (FIG. 1), from the source code and various supplementary data sources. For simplicity, the build service 421 and the data in the data store 412 is described throughout this disclosure in the context of building executable code for the application service 121. However, as one skilled in the art can appreciate, the build service 421 may be used to build other applications beyond the application service 121.

The data stored in the data store 412 includes, for example, source code 431, UI language data 433, configuration data 435, executable code 437, and potentially other data. The source code 431 includes source code written in one or more programming languages (e.g. C, C⁺⁺, Java, etc.) that is used to produce executable code for the application service 121 and potentially other applications. The source code present in the source code 431 can be used in conjunction with various supplementary data sources in order to build the executable application service 121. The UI language data 433 is an example of a supplementary data source that includes data to be used to support the various language offerings of the user interface 165 for the application service 121. For example, the UI language data 433 may include text strings in various written languages to be used within the user interface 165, animations in one or more sign languages to be used within the user interface 165, and/or other possible data.

The configuration data 435 includes various data associated with configuring the build service 421 to build the executable code for the application service 121 and potentially other applications. The configuration data 435 may include languages for which the application service 121 should support, user credentials, types of processors for which the application service 121 should be built (e.g. x86, ARM, MIPS, etc.), user permissions, preferences, and/or other possible data. The executable code 437 includes the various files produced that are needed in order for the application service 121 and potentially other applications to be executed by a processor of a computing device.

The client 406 is representative of a plurality of client devices that may be coupled to the network 409. The client 406 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. The client 406 may include a display 461. The display 461 may comprise, for example, one or more devices such as LCD displays, gas plasma-based flat panel displays, OLED displays, E ink displays, LCD projectors, or other types of display devices, etc.

The client 406 may be configured to execute various applications such as a client application 463 and/or other applications. The client application 463 may be executed in a client 406, for example, to access network content served up by the computing environment 403 and/or other servers, thereby rendering a user interface 465 on the display 461. To this end, the client application 406 may comprise, for example, a browser, a dedicated application, etc., and the user interface 465 may comprise a network content page, an application screen, etc. The client 406 may be configured to execute applications beyond the client application 463 such as, for example, email applications, social networking applications, word processors, spreadsheets, and/or other applications.

Next, a general description of the operation of the various components of the networked environment 400 is provided. To begin, a user operating the client 406 employs the client application 463 to establish a communication session with the build service 421. The communication session may be carried out using various protocols such as, for example, HTTP, SOAP, REST, UDP, TCP, and/or other protocols for communicating data over the network 409. In some implementations, the user is authenticated to the build service 421 using one or more user credentials.

Various such communication sessions may be established from various clients 406 during the course of developing source code for the application service 121. Regarding development of the user interface 165 for the application service 121, the source code may refer to an identifier for each text string that should appear in the user interface, where the identifier refers to data within the UI language data 433 that expresses the string in one or more languages.

For example, within the menu 205 of the user interface 165 shown in FIGS. 2 and 3, various interface elements are present and identified using text strings such as “File,” “Edit,” and “View,” among others. In the source code associated with generating the user interface 165, the strings that should be used for these interface elements may be identified using identifiers such as [S001], [S002], and [S003], respectively. Continuing the example, for each of the identifiers, one or more strings may exist in the UI language data 433 that correspond to the intended word or phrase expressed in a different language, such as for the identifier [S001], the UI language data 433 may include the strings “File” for English and “Archivar” for Spanish. If the build service 421 is requested to build executable code for the application service 121 that includes a user interface 165 capable of supporting both English and Spanish, for each identifier in the source code, the executable code will include the corresponding English and Spanish strings that are extracted from the UI language data 433. Similarly, the UI language data 433 may also already include one or more sign language animations associated with identifiers used in the source code.

A new sign language may be added to the UI language data 433 by first retrieving a text string corresponding to each identifier within the source code for the user interface 165 of the application service 121. In some embodiments in which more than one text string is available for each identifier (i.e. more than one written language is supported), the text strings retrieved may be from a default or core language used to develop the user interface.

Once the text string is obtained, a developer using the client 406 may then produce a translation of the text string from its written language to an animation in a sign language. The animations may be computer-generated imagery (CGI) or live-action captured from a sign language presenter. The animations may be stored in one or more formats, such as Adobe Flash®, MPEG-1/2/4, animated GIF, animated PNG, and/or other possible data formats as can be appreciated. The sign languages may include American Sign Language (ASL), Brazilian Sign Language (LSB), Indo-Pakistani Sign Language (IPSL), Chinese Sign Language (CSL), and/or other possible sign languages.

Thereafter, the developer may store the animation in the UI language data 433 using the identifier corresponding to the text string that was translated into the sign language, and further indicating the particular type of sign language used in the animation. Using one or more clients 406, these translation operations may continue until each identifier within the source code for the user interface 165 has been translated into the desired sign language(s). In some implementations, in addition to sign language animations, the developer may also store translations of the various text strings in the UI language data 433 into other written languages.

Subsequently, the build service 421 can be configured to build executable code for the application service 121 that includes support for one or more languages in the user interface 165. When the languages configured for a build include a sign language, for each identifier in the source code, the executable code will include strings that correspond to each requested written language and animations that correspond to each requested sign language, all of which are extracted from the UI language data 433 using the identifiers. Thus, for example, any given identifier can be used to extract an English string, a Spanish, and a sign language animation for a particular interface element. As such, when the application service 121 is executed in the various possible computing devices, the user interface 165 can be configured to use any of the languages that the application service 121 was built to support.

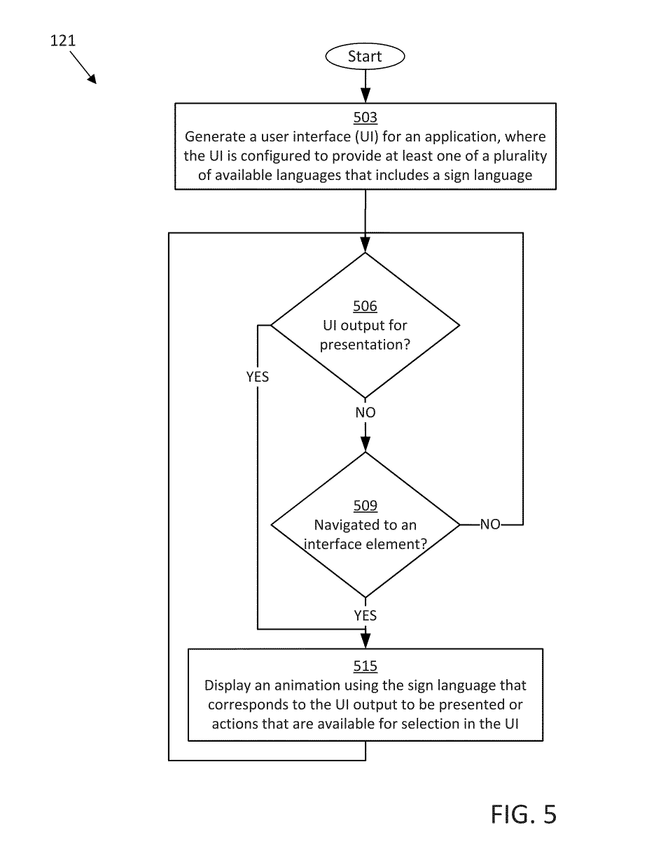

Referring next to FIG. 5, shown is a flowchart that provides one example of the operation of a portion of the application service 121 according to various embodiments. It is understood that the flowchart of FIG. 5 provides merely an example of the many different types of functional arrangements that may be employed to implement the operation of the portion of the application service 121 as described herein. As an alternative, the flowchart of FIG. 5 may be viewed as depicting an example of elements of a method implemented in the computing environment 103 according to one or more embodiments.

Beginning with block 503, the application service 121 executing in a computing device generates a user interface in at least one of a plurality of available languages that includes a sign language. For example, the user interface may be offered in a written language, such as English or Hindi, as well as in a sign language, such as ASL or IPSL. As described previously, execution of the application service 121 may occur in the same computing device in which the user interface for the application service 121 is rendered, or execution of the application service 121 may occur in a separate computing device from that in which the user interface for the application service 121 is rendered.

Next, in block 506, the application service 121 determines whether the user interface includes any application-generated, written UI output that should be presented to the user through an animation in the sign language. Based upon user preferences and/or a configuration of the application service 121, the animation may include presenting the written menu items available in the user interface, an initial tutorial of the application service 121 and/or the user interface, any error or warning messages produced in the user interface, and/or other possible information. If UI output should be presented in an animation, execution of the application service 121 proceeds to block 515 whether an animation corresponding to the UI output is displayed in an animation window of the user interface. Alternatively, if no UI output needs to be presented, execution of the application service 121 proceed to block 509.

In block 509, the application service 121 determines whether any input is received from a user navigating to an interface element of the user interface associated with one or more actions. For example, activating an interface element for a menu item that includes a submenu, a right-click of a mouse to display a context menu, hovering a pointer over an interface element for a submenu item, scrolling among interface elements of menu items, etc. The input may be received from an input device and can include, for example, moving a pointer, entering text through a keyboard, a click of a mouse, etc.

If input is not received for navigating to an interface element, execution of the application service 121 returns to block 506. Alternatively, if such input is received, in block 515, the application service 121 proceeds to block 515 where an animation associated with the possible action(s) is presented in the sign language. For example, if the user selects “File” from the main menu of the user interface, a submenu may be displayed and a series of animations presented that lists the various items within the “File” submenu, such as “Open,” “Save,” “Print,” etc. If the user moves a pointer in the user interface to hover over a particular submenu item, an animation can be presented for only the particular submenu item. Subsequently, execution of the application service 121 returns to block 506, to continue monitoring for events for which an animation should be presented.

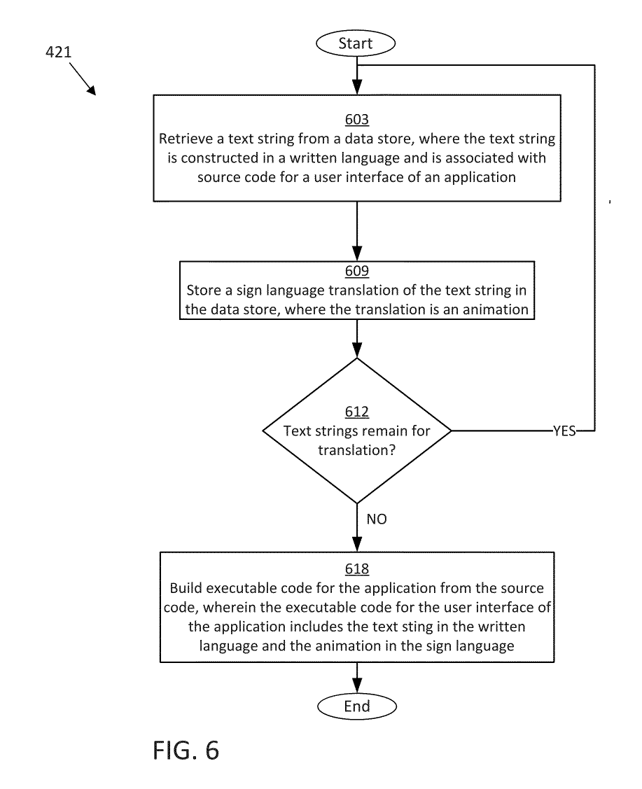

Referring next to FIG. 6, shown is a flowchart that provides one example of the operation of a portion of the build service 421 according to various embodiments. It is understood that the flowchart of FIG. 6 provides merely an example of the many different types of functional arrangements that may be employed to implement the operation of the portion of the build service 421 as described herein. As an alternative, the flowchart of FIG. 6 may be viewed as depicting an example of elements of a method implemented in the computing environment 403 according to one or more embodiments. This portion of the build service 421 may be executed in response to a request to prepare sign language translations of text strings specified in source code for a user interface of the application service 121. The translations may be performed in preparation to build executable code for the application service 121 that includes a user interface offering the sign language.

To begin, in block 603, a text string associated with source code for a user interface of the application service 121 is retrieved from a data store. The text string is constructed in a written language (e.g. English, Hindi, Spanish, etc.) and may be used in various possible portions of a user interface, such as menus, links, error messages, banners, and so on. In some embodiments, the source code may include an identifier that specifies one or more text strings from the data store that express similar meaning, each in a different written language. In these embodiments, the particular string retrieved may depend upon a user preference, a default or core language to be used to develop the user interface, and/or other selection criteria.

Once the text string is obtained, a developer using the client 406 may then produce a translation of the text string from its written language to an animation in a sign language. The animations may be stored in one or more formats, such as Adobe Flash®, MPEG-1/2/4, animated GIF, animated PNG, and/or other possible data formats as can be appreciated. The sign languages may include American Sign Language (ASL), Brazilian Sign Language (LSB), Indo-Pakistani Sign Language (IPSL), Chinese Sign Language (CSL), and/or other possible sign languages.

Next, in block 609, the developer may store the sign language translation of the text string (i.e. an animation) in the data store, where the translation is associated with the text string. In some embodiments, the translation is stored using the identifier corresponding to the text string that was translated into the sign language, and further indicating the particular type of sign language used in the animation.

Then, in block 612, the build service 421 determines whether text strings remain for which no translation from a written language to a sign language has been performed. If text strings remain that have not been translated, then execution of the build service 421 may return to block 603 to begin translating the remaining text strings. Alternatively, if a complete set of sign language translations exists for the text strings, then in block 618, the build service 421 can build executable code for the application service 121 that includes support for one or more languages in the user interface 165, including a sign language. Depending upon the particular languages the build service 421 requested to include in the executable code, the code will include strings that correspond to each requested written language and animations that correspond to each requested sign language, all of which are extracted from the UI language data 433. As such, when the application service 121 is executed in the various possible computing devices, the user interface 165 can be configured to use any of the languages with which the application service 121 was built to support. Thereafter, execution of this portion of the build service 421 may end as shown.

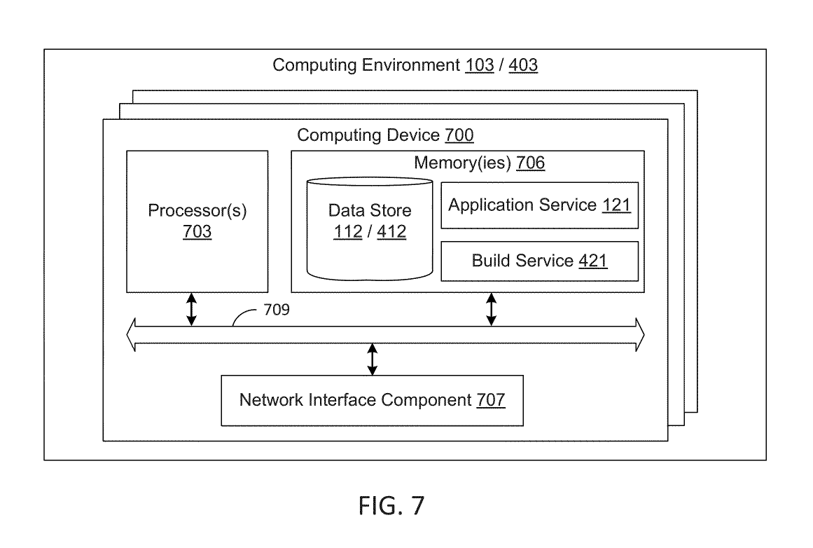

With reference to FIG. 7, shown is a schematic block diagram of the computing environment 103/403 according to an embodiment of the present disclosure. The computing environment 103/403 includes one or more computing devices 700. Each computing device 700 includes at least one processor circuit, for example, having a processor 703, a memory 706, and a network interface 707, all of which are coupled to a local interface 709. To this end, each computing device 700 may comprise, for example, at least one server computer or like device. The local interface 709 may comprise, for example, a data bus with an accompanying address/control bus or other bus structure as can be appreciated.

Stored in the memory 706 are both data and several components that are executable by the processor 703. In particular, stored in the memory 706 and executable by the processor 703 are the application service 121, the build service 421, and potentially other applications. Also stored in the memory 706 may be a data store 112/412 and other data. In addition, an operating system may be stored in the memory 706 and executable by the processor 703.

It is understood that there may be other applications that are stored in the memory 706 and are executable by the processor 703 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 706 and are executable by the processor 703. In this respect, the term “executable” means a program file that is in a form that can ultimately be run by the processor 703. Examples of executable programs may be, for example, a compiled program that can be translated into machine code in a format that can be loaded into a random access portion of the memory 706 and run by the processor 703, source code that may be expressed in proper format such as object code that is capable of being loaded into a random access portion of the memory 706 and executed by the processor 703, or source code that may be interpreted by another executable program to generate instructions in a random access portion of the memory 706 to be executed by the processor 703, etc. An executable program may be stored in any portion or component of the memory 706 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 706 is defined herein as including both volatile and nonvolatile memory and data storage components. Volatile components are those that do not retain data values upon loss of power. Nonvolatile components are those that retain data upon a loss of power. Thus, the memory 706 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 703 may represent multiple processors 703 and/or multiple processor cores and the memory 706 may represent multiple memories 706 that operate in parallel processing circuits, respectively. In such a case, the local interface 709 may be an appropriate network that facilitates communication between any two of the multiple processors 703, between any processor 703 and any of the memories 706, or between any two of the memories 706, etc. The local interface 709 may comprise additional systems designed to coordinate this communication, including, for example, performing load balancing. The processor 703 may be of electrical or of some other available construction.

Although the application service 121, the build service 421, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 5 and 6 show the functionality and operation of an implementation of portions of the application service 121 and the build service 421, respectively. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 703 in a computer system or other system. The machine code may be converted from the source code, etc. If embodied in hardware, each block may represent a circuit or a number of interconnected circuits to implement the specified logical function(s).

Although the flowcharts of FIGS. 5 and 6 show a specific order of execution, it is understood that the order of execution may differ from that which is depicted. For example, the order of execution of two or more blocks may be scrambled relative to the order shown. Also, two or more blocks shown in succession in FIGS. 5 and 6 may be executed concurrently or with partial concurrence. Further, in some embodiments, one or more of the blocks shown in FIGS. 5 and 6 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the application service 121 and the build service 421, that comprises software or code can be embodied in any non-transitory computer-readable medium for use by or in connection with an instruction execution system such as, for example, a processor 703 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the application service 121 and the build service 421, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 700, or in multiple computing devices in the same computing environment 103/403. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A method, comprising:
generating, in a computing device, a user interface (UI) for an application, wherein the UI is configured to provide at least one of a plurality of available languages that includes a sign language;
receiving, in the computing device, input from a user navigating to an interface element of the UI that presents one or more actions of the application that are available for selection; and
in response to the user navigating to the interface element of the UI, displaying, in the computing device, an animation using the sign language that corresponds to the one or more actions that are available for selection.

2. The method of claim 1, further comprising receiving, in the computing device, input selecting the at least one language provided by the UI of the application.

3. The method of claim 1, further comprising changing, in the computing device, the animation in response to the user navigating to a different interface element of the UI.

4. The method of claim 1, wherein the interface element of the UI presents the one or more actions based at least in part upon a written language that is used simultaneously with the sign language of the animation.

5. The method of claim 1, further comprising:
selecting, with an input device of the computing device, one of the one or more actions from the interface element of the UI; and
initiating the selected action in the computing device.

6. The method of claim 1, wherein the sign language is selected from among the group comprising: American Sign Language (ASL), Brazilian Sign Language (LSB), Indo-Pakistani Sign Language (IPSL), and Chinese Sign Language (CSL).

7. The method of claim 1, wherein the animation using the sign language can be enabled or disabled in the application.

8. The method of claim 1, wherein the animation is displayed in a portion of the UI that can be moved to various locations within the UI.

9. A system, comprising:
at least one computing device; and
a build service executed in the at least one computing device, the build service comprising:
logic that retrieves a text string from a data store, wherein the text string is constructed in a written language and is associated with source code for a user interface of an application;
logic that stores, in the data store, a translation of the text string from the written language to a sign language, wherein the translation is an animation in the sign language; and
logic that builds executable code for the application from the source code, wherein the executable code for the user interface of the application includes the text sting in the written language and the animation in the sign language.

10. The system of claim 9, wherein the sign language comprises at least one of: American Sign Language (ASL), Brazilian Sign Language (LSB), Indo-Pakistani Sign Language (IPSL), and Chinese Sign Language (CSL).

11. The system of claim 9, wherein the build application further comprises logic that stores, in the data store, a second translation of the text string from the written language to a second written language, the second translation being a second text string constructed in the second written language.

12. The system of claim 9, wherein the logic that builds the executable code for the application, builds a plurality of executable codes for a plurality of different processors.

13. The system of claim 9, wherein the executable code for the application, permits the animation for the sign language to be enabled or disabled in the user interface.

14. A non-transitory computer-readable medium embodying a program executable in at least one computing device, comprising:
code that generates a user interface (UI) for an application, wherein the UI is configured to provide at least one of a plurality of available languages that includes a sign language;
code that receives input from a user navigating to an interface element of the UI to present one or more actions of the application that are available for selection; and
code that in response to the user navigating to the interface element of the UI, displays an animation using the sign language that corresponds to the one or more actions that are available for selection.

15. The non-transitory computer-readable medium of claim 14, wherein the interface element of the UI presents the one or more actions based at least in part upon a written language that is used simultaneously with the sign language of the animation.

16. The non-transitory computer-readable medium of claim 14, wherein the sign language is American Sign Language (ASL).

17. The non-transitory computer-readable medium of claim 14, wherein the program further comprises:
code that responds to selecting, with an input device, one of the one or more actions from the interface element of the UI; and
code that initiates the selected action in the at least one computing device.

18. The non-transitory computer-readable medium of claim 14, wherein the animation using the sign language can be enabled or disabled in the application.

19. The non-transitory computer-readable medium of claim 14, wherein the animation is displayed in a portion of the UI that can be moved to various locations within the UI.

20. The non-transitory computer-readable medium of claim 14, further comprising code that receives, from the user, input selecting the at least one language provided by the UI of the application.
